(19) United States
(12) Patent Application Publication
(10) Pub. No.: US 2009/0321150 A1
(43) Pub. Date: Dec. 31, 2009

(54) Walking robot and method of controlling the same

(75) Inventors: Woong Kwon, Seongnam-si (KR); Hyun Kyu Kim, Seoul (KR); SukJune Yoon, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/382,188

(22) Filed: Mar. 10, 2009

(30) Foreign Application Priority Data
Jun. 27, 2008 (KR) 10-2008-61523

(51) Int. Cl. G05B 19/04; B62D 57/032; G06F 19/00; B62D 57/02

(52) U.S. Cl. 180/8.6; 700/250; 901/1

(57) ABSTRACT

Disclosed are a walking robot and a method of controlling the same, in which one method is selected from a ZMP control method and a FSM control method. Based on characteristics of a motion to be performed, the current control mode of the walking robot is converted into a different control mode, and the motion is performed based on the converted control mode, to enhance the efficiency and performance of the walking robot. The method includes receiving an instruction to perform a motion; selecting any one mode, which is determined to be more proper to perform the instructed motion, out of a position-based first control mode and a torque-based second control mode; and performing the instructed motion according to the selected control mode.

### CROSS-REFERENCE TO RELATED APPLICATIONS

This application claims the benefit of Korean Patent Application No. 2008-0061523, filed Jun. 27, 2008, in the Korean Intellectual Property Office, the disclosure of which is incorporated herein by reference.

### BACKGROUND

1. Field

The present invention relates to a robot, and more particularly to a walking robot with a plurality of legs, which walks using the plurality of legs, and a method of controlling the same.

2. Description of the Related Art

In general, robots refer to machines, which conduct motions similar to those of a human. Early robots were industrial robots, such as manipulators or transfer robots for automation and unmanned operation of production in production sites. Recently, a walking robot, which models the biped walking of a human, has been researched and developed. The biped walking has disadvantages, such as instability and difficulty in pose control or walking control, as compared with the quadruped or hexapod walking, but has advantages, such as more flexibly coping with an uneven surface of the ground (i.e., a rugged road) or a discontinuous walking surface (for example, stairs).

Methods of controlling a walking robot include a position-based zero moment point (ZMP) control method, and a torque-based dynamic walking control method or finite state machine (FSM) control method. The dynamic walking control method or FSM control method refers to all systems, which use torque control but do not use ZMP control. In the ZMP control method, a biped walking robot predetermines a walking direction, a step length, a walking speed, etc., generates walking patterns of respective legs corresponding to the above predetermination, and calculates walking trajectories of the respective legs according to the walking patterns. Further, the biped walking robot calculates positions of joints of the respective legs through inverse kinematics calculations of the calculated walking trajectories, and calculates target control values of motors of the respective joints based on current positions and target positions of the motors of the respective joints. Further, this process is achieved through servo control to cause the respective legs to follow the calculated walking trajectories. Thus, it is detected whether or not the positions of the respective legs precisely follow the walking trajectories according to the walking patterns, and torques of the motors are controlled such that the respective legs precisely follow the walking trajectories, when the respective legs are deviated from the walking trajectories. In the FSM control method, states of respective motions of a walking robot are defined in advance (i.e., finite states), and the robot walks properly with reference to the respective states while walking. In the FSM control method, FSM and states (here, states refer to states in the finite state machines) of the respective motions of the walking robot are defined in advance, and the walking robot properly walks with reference to the states of the respective motions while walking. For example, as disclosed in a document [K. Yin, K. Loken, M. Panne, “SIMBICON: Simple Biped Locomotion Control”, SIGG2007], a control input required by a defined FSM and conversion of states in the FSM is determined, and instructions of respective portions of the body of the robot, such as a torso, swing legs, etc., for balance and walking are calculated according to the determined control input. Thereafter, an error is repaired by feedback so as to maintain balance, and actuators are driven according to values obtained by the feedback, thus achieving the walking of the robot.

The ZMP control method is a position-based control method and thus can control a precise position, but requires a high servo gain and thus has a low energy efficiency and a high stiffness and applies a large impact to surroundings.

The FSM control method performs control according to a torque instruction and is applied to an elastic mechanism, and thus has a high energy efficiency and a low stiffness and provides safety to surroundings. However, the FSM method cannot control a precise position, and thus causes a difficulty in performing a precise motion of the whole body of the robot, such as ascending the stairs or avoiding an obstacle.

### SUMMARY

Therefore, one aspect of the present invention is to provide a walking robot and a method of controlling the same, in which one method is selected from a ZMP control method and an FSM control method in consideration of characteristics of a motion to be performed, the current control mode of the walking robot is converted into a different control mode, and the motion is performed based on the converted control mode, to enhance the efficiency and performance of the walking robot.

Additional aspects and/or advantages will be set forth in part in the description which follows and, in part, will be apparent from the description, or may be learned by practice of the invention.

The foregoing and/or other aspects of the present invention are achieved by providing a method of controlling a walking robot, including receiving an instruction to perform a motion; selecting any one mode, comprising determining which mode is more proper to perform the received instruction, out of a position-based first control mode and a torque-based second control mode; and performing the instructed motion according to the selected control mode.

The first control mode may be a ZMP-based control mode; and the second control mode may be an FSM-based control mode. The ZMP-based control mode may be selected when the instructed motion to be performed requires precise position control. The conversion between the first control mode and the second control mode may be carried out in order to perform the instructed motion.

The conversion from the first control mode to the second control mode may include calculating position errors between current positions and target positions of the walking robot; calculating increase displacements of the walking robot through the position errors; and converting the first control mode into the second control mode, when the increase displacements are not larger than a predetermined value.

The increase displacements of the walking robot may include an increase displacement of a torso of the walking robot and an increase displacement of a swing leg of the walking robot.

The conversion from the first control mode to the second control mode may further include obtaining interpolated increase displacements, when the increase displacements are larger than the predetermined value; and performing the instructed motion based on the interpolated increase displacements.

The control mode of the walking robot may be set again to the first control mode in preparation for the subsequent conversion from the first control mode to the second control mode, when the interpolated increase displacements are obtained.

The substantial performance of the instructed motion may be achieved in the second control mode, although the control mode of the walking robot is set again to the first control mode.

The conversion from the second control mode to the first control mode may include calculating a ZMP error between a current ZMP and a target ZMP of the walking robot; calculating an increase displacement of the walking robot through the ZMP error; and converting the second control mode into the first control mode, when the increase displacement is not larger than a predetermined value.

The increase displacement of the walking robot is an increase displacement of a center of gravity (COG) of the walking robot.

The conversion from the second control mode to the first control mode may further include obtaining an interpolated increase displacement, when the increase displacement is larger than the predetermined value; and performing the instructed motion based on the interpolated increase displacement.

The control mode of the walking robot may be set again to the second control mode in preparation for the subsequent conversion from the second control mode to the first control mode, when the interpolated increase displacement is obtained.

The substantial performance of the instructed motion may be achieved in the first control mode, although the control mode of the walking robot is set again to the second control mode.

The foregoing and/or other aspects of the present invention are achieved by providing a walking robot including a torso; a plurality of legs supporting the torso; and a controller receiving an instruction to perform a motion, selecting any one mode, which is determined to be more proper to perform the instructed motion, out of a position-based first control mode and a torque-based second control mode, and performing the instructed motion according to the selected control mode.

The first control mode may be a ZMP-based control mode; and the second control mode may be an FSM-based control mode. The controller may select the ZMP-based control mode when the instructed motion to be performed requires precise position control. The controller may carry out the conversion between the first control mode and the second control mode in order to perform the instructed motion. The controller may include a state data storing unit to store predetermined state data to perform the FSM-based control mode.

The foregoing and/or other aspects may be achieved by providing a method of controlling a walking robot, comprising determining a difficulty and a slope of a surface on which the robot walks; selecting an FSM-based walking control if the slope is even and the difficulty is relatively easy; and selecting a ZMP-based walking control if the slope is not even or the difficulty is relatively difficult.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a schematic view illustrating a walking robot in accordance with an embodiment of the present invention;

FIG. 2 is a view illustrating joint structures of the walking robot of FIG. 1;

FIG. 3 is a view illustrating a control system of the walking robot in accordance with the embodiment of the present invention;

FIG. 4 is a view illustrating a method of controlling the walking robot in accordance with the embodiment of the present invention;

FIG. 5 is a view illustrating a method of converting a ZMP-based control mode into a FSM-based control mode in the walking robot in accordance with the embodiment of the present invention; and

FIG. 6 is a view illustrating a method of converting an FSM-based control mode into a ZMP-based control mode in the walking robot in accordance with the embodiment of the present invention.

### DETAILED DESCRIPTION OF EMBODIMENTS

Reference will now be made in detail to the embodiment of the present invention, an example of which is illustrated in the accompanying drawings, wherein like reference numerals refer to like elements throughout. The embodiment is described below to explain the present invention by referring to the figures.

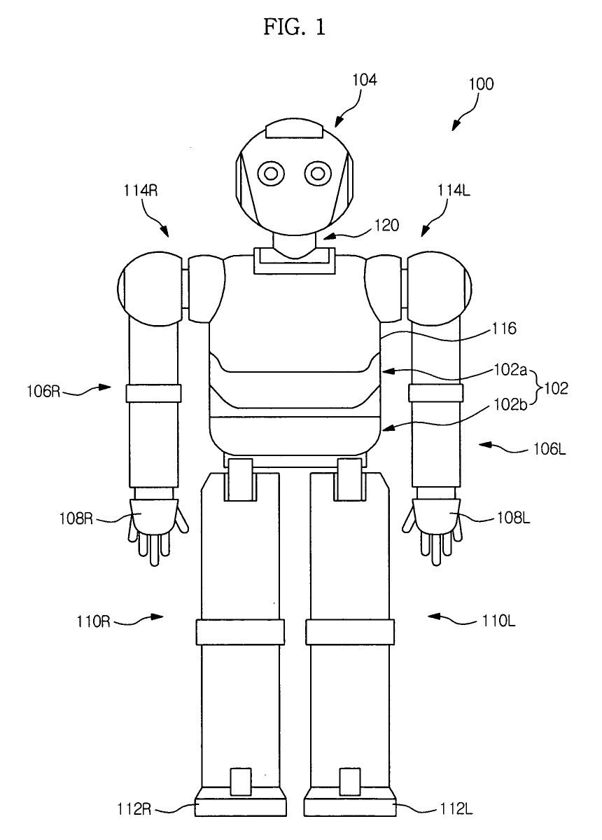

FIG. 1 is a schematic view illustrating a walking robot in accordance with an embodiment of the present invention. As shown in FIG. 1, a head 104 is connected to the upper portion of a torso 102 of a walking robot 100 through a neck 120. Two arms 106L and 106R are connected to both sides of the upper portion of the torso 102 of the walking robot 100 through shoulders 114L and 114R. Hands 108L and 108R are respectively connected to tips of the two arms 106L and 106R. Two legs 110L and 110R are connected to both sides of the lower portion of the torso 102. Feet 112L and 112R are respectively connected to the two legs 110L and 100R. The head 104, the two arms 106L and 106R, the two legs 110L and 110R, and the two hands 108a and 108b, and the two feet 112L and 112R respectively have designated degrees of freedom through joints. The inside of the torso 102 is protected by a cover 116. The torso 102 is divided into a breast 102a and a waist 102b. Here, L represents the left side of the walking robot 100, and R represents the right side of the walking robot.

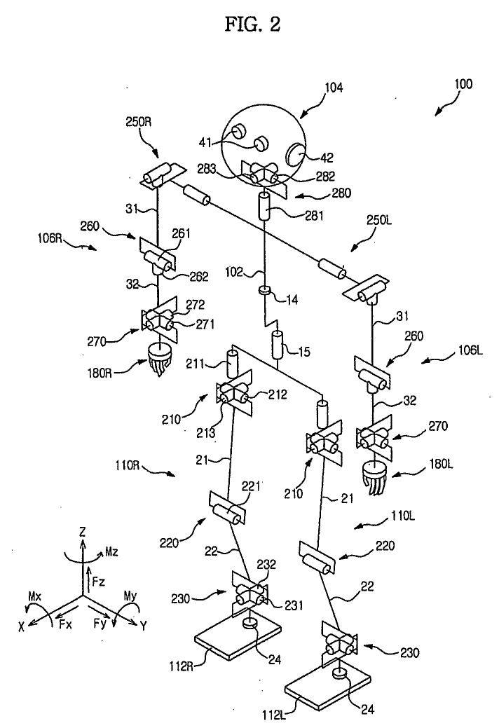

FIG. 2 is a view illustrating joint structures of the walking robot of FIG. 1. As shown in FIG. 2, the two legs 110L and 110R of the walking robot 100 respectively include thigh links 21, calf links 22, and the feet 112L and 112R. The thigh links 21 are connected to the torso 102 by thigh joint units 210. The thigh links 21 and the calf links 22 are connected to each other by knee joint units 220, and the calf links 22 and the feet 112L and 112R are connected to each other by ankle joint units 230.

The thigh joint units 210 have 3 degrees of freedom. Specifically, the thigh joint units 210 respectively include rotary joints 211 in a yaw direction (in a rotating direction on the z-axis), rotary joints 212 in a pitch direction (in a rotating direction on the y-axis), and rotary joints 213 in a roll direction (in a rotating direction on the x-axis).

The knee joint units 220 respectively include rotary joints 221 in the pitch direction, and thus have 1 degree of freedom. The ankle joint units 230 respectively include rotary joints 231 in the pitch direction and rotary joints 232 in the roll direction, and thus have 2 degrees of freedom.

Since the two legs 110L and 110R respectively include six rotary joints of three joint units 210, 220 and 230, as described above, the walking robot 100 includes twelve rotary joints.

Multi-axis force and torque (F/T) sensors 24 are respectively installed between the feet 112L and 112R and the ankle joint units 230 of the two legs 110L and 110R. The multi-axis F/T sensors 24 measure three-directional components (Mx, My, Mz) of torque and three-directional components (Fx, Fy, Fz) of force transmitted from the feet 112L and 112R, and thus detect whether or not the legs 112L and 112R land and also detect a load applied to the feet 112L and 112R.

Cameras 41 serving as eyes of the walking robot 100 and microphones 42 serving as ears of the walking robot 100 are installed on the head 104.

The head 104 is connected to the torso 102 by a neck joint unit 280. The neck joint unit 280 includes a rotary joint 281 in the yaw direction, a rotary joint 282 in the pitch direction, and a rotary joint 283 in the roll direction, and thus has 3 degrees of freedom.

Motors (not shown) for rotating the head 104 are respectively connected to the rotary joints 281, 282, and 283 of the neck joint unit 280.

Shoulder joint assemblies 250L and 250R are installed at both sides of the torso 102, and connect the two arms 106L and 106R to the torso 102.

The two arms 106L and 106R respectively include upper arm links 31, lower arm links 32, and the hands 108L and 108R. The upper arm links 31 are connected to the torso 102 by the shoulder joint assemblies 250L and 250R. The upper arm links 31 and the lower arm links 32 are connected to each other by elbow joint units 260, and the lower arm links 32 and the hands 108L and 108R are connected to each other by wrist joint units 270.

The elbow joint units 260 respectively include rotary joints 261 in the pitch direction and rotary joints 262 in the yaw direction, and thus have 2 degrees of freedom. The wrist joint units 270 respectively include rotary joints 271 in the pitch direction and rotary joints 272 in the yaw direction, and thus have 2 degrees of freedom.

Five fingers 33a are respectively installed on each of the hands 108L and 108R. A plurality of joints (not shown), each of which is driven by a motor, are respectively installed on the fingers 33a. The fingers 33a interlock with the motion of the arms 106L and 106R, and perform various motions, such as gripping an object or pointing out a specific direction.

A pose sensor 14 is installed on the torso 102. The pose sensor 14 detects a tilt angle of the pose 102 to a perpendicular axis and its angular velocity, and generates pose data. The pose sensor 14 may be installed on the head 104 as well as the torso 102. Further, a rotary joint 15 in the yaw direction to rotate the breast 102a against the waist 102b is installed between the breast 102a and the waist 102b of the torso 102.

Although not shown in the drawings, motors to respectively drive the rotary joints are installed on the walking robot 100. A controller, which controls the whole operation of the walking robot 100, properly controls the motors, thus allowing the walking robot 100 to perform various motions.

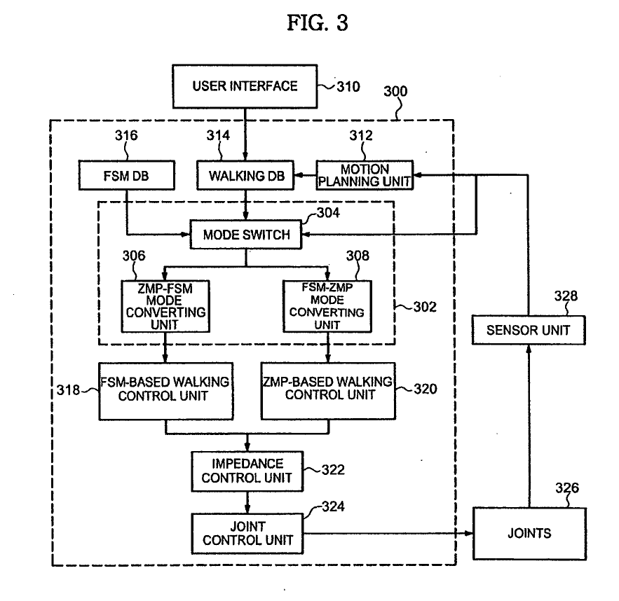

FIG. 3 is a view illustrating a control system of the walking robot in accordance with the embodiment of the present invention. A controller 300 of FIG. 3 basically performs walking control of the walking robot 100. Further, the controller 300 selects any one of FSM-based walking control and ZMP-based walking control according to walking conditions of the walking robot 100 (whether or not the walking surface is even, whether or not there is an obstacle, etc., and thus controls the walking of the walking robot 100. The FSM-based walking control is walking control based on a torque, and the ZMP-based walking control is walking control based on a position. The controller 300 selects FSM-based walking control when the walking robot 100 walks on the even surface of land or comparatively simple walking of the walking robot 100 is controlled. On the other hand, the controller 300 selects ZMP-based walking control when a step length is designated due to the rough surface of land, such as stairs, or an obstacle or control of a precise motion of the whole body of the walking robot 100, such as opening a door or shifting an object, is required.

A mode setting unit 302 of the controller 300 includes a mode switch 304, a ZMP-FSM mode converting unit 306, and a FSM-ZMP mode converting unit 308. The mode switch 304 activates any one of the ZMP-FSM mode converting unit 306 and the FSM-ZMP mode converting unit 308 based on a current control mode (a FSM control mode or a ZMP control mode) of the walking robot 100, a user instruction inputted from the outside through a user interface 310, and a target motion of the walking robot 100 inputted through a motion planning unit 312, and thus reciprocally converts the walking control methods of the walking robot 100. Further, when the walking control methods of the walking robot 100 are reciprocally converted into each other, the mode switch 304 refers to walking control data of a walking database 314, FSM control data of a FSM database (a state data storing unit) 316, and a force applied to the sole of the foot, torques of the respective joints, a pose (a tilt) of the torso, visual data, and audio data, which are measured by a sensor unit 328.

The ZMP-FSM mode converting unit 306 converts the control mode of the walking robot 100 from a ZMP-based control mode (a first control mode) to a FSM-based control mode (a second control mode). When the control mode of the walking robot 100 is converted into the FSM-based control mode, a FSM-based walking control unit 318 controls the motion of the walking robot 100 by the FSM control method. FSM-ZMP mode converting unit 308 converts the control mode of the walking robot 100 from the FSM-based control mode to the ZMP-based control mode. When the control mode of the walking robot 100 is converted into the ZMP-based control mode, a ZMP-based walking control unit 320 controls the motion of the walking robot 100 by the ZMP control method. The control of the walking robot 100 is achieved by controlling impedances (stiffnesses) of the respective joints 326 through an impedance control unit 322 and controlling torques/positions of the respective joints 326 through a joint control unit 324.

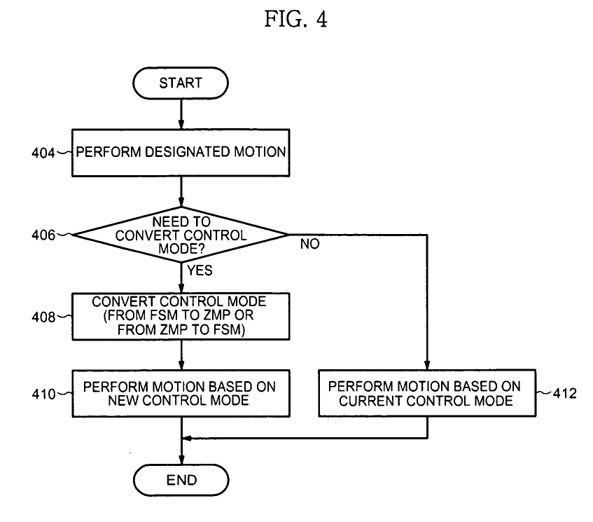

FIG. 4 is a view illustrating a method of controlling the walking robot in accordance with the embodiment of the present invention. As shown in FIG. 4, in the method of controlling the walking robot in accordance with the embodiment of the present invention, when a new instruction to perform a motion is inputted, when the new instructed motion requires the conversion of the control mode of the walking robot 100, the control mode of the walking robot 100 is converted into a preferable control mode to perform a corresponding motion and the walking robot 100 is controlled in the converted control mode.

First, when a new instruction to perform a motion is generated (operation 404), it is determined whether or not there is need to convert the current control mode of the walking robot 100 into a different control mode to perform a motion according to the new instructed motion (operation 406). For example, when the motion performed according to the new instructed motion is walking on the even surface of land or comparatively simple walking, the FSM-based control mode is selected. On the other hand, when a step length is designated due to the uneven surface of land, such as stairs, or an obstacle or control of a precise motion of the whole body of the walking robot 100, such as opening a door or shifting an object, is required, the ZMP-based walking control mode is selected.

When the conversion of the control mode is required (yes of operation 406), the current control mode of the walking robot 100 is converted into a control mode necessary for the motion of the new instructed motion (operation 408). When the control mode is converted, the walking robot 100 performs a motion based on the converted control mode (operation 410). On the other hand, when the conversion of the control mode is not required (no of operation 406), the walking robot 100 performs a motion based on the current control mode (operation 412).

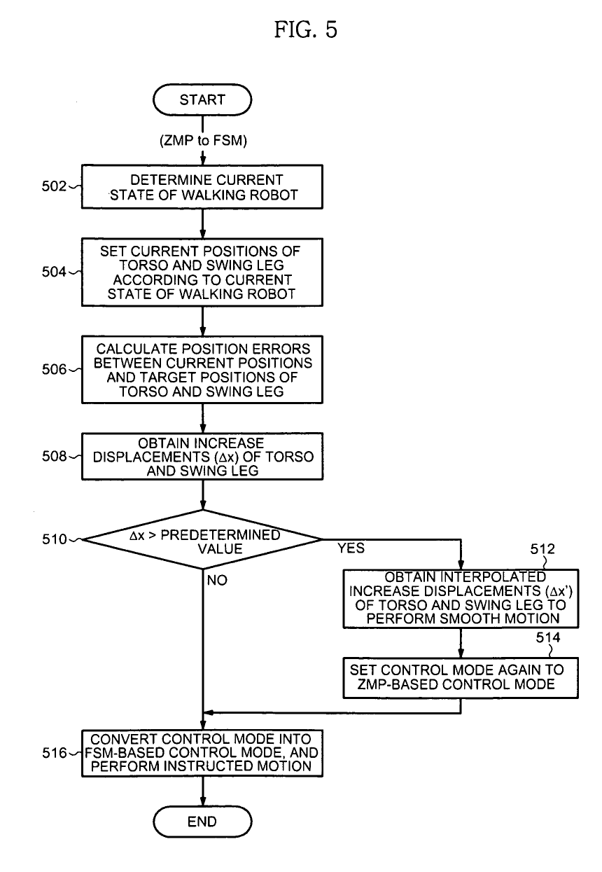

FIG. 5 is a view illustrating a method of converting a ZMP-based control mode into a FSM-based control mode in the walking robot in accordance with the embodiment of the present invention. As shown in FIG. 5, when ZMP-based walking control is performed, the current state (state in the FSM) of the walking robot 100 is inferred from the data of the motion planning unit 312 or the data of the sensor unit 328 (operation 502). Current positions of the torso 102 and a swing leg 110L or 110R according to the current state of the walking robot 100 are set (operation 504). Position errors between the current positions and target positions of the torso 102 and the swing leg 110L or 110R of the walking robot 100 are calculated (operation 506). Increase displacements (Δx) of the torso 102 and the swing leg 110L or 110R are obtained from the position errors of the torso 102 and the swing leg 110L or 110R (operation 508). When the increase displacements (Δx) of the torso 102 and the swing leg 110L or 110R are larger than a predetermined value (yes of operation 510), interpolated increase displacements (Δx′) of the torso 102 and the swing leg 110L or 110R are obtained (operation 512). The interpolated increase displacements (Δx′) serve to prevent the excessive motion of the torso 102 and the swing leg 110L or 110R such that the torso 102 and the swing leg 110L or 110R can smoothly move. After the interpolated increase displacements (Δx′) are obtained, the control mode of the walking robot 100 is set again to the ZMP-based control mode (operation 514). On the other hand, when the increase displacements (Δx) of the torso 102 and the swing leg 110L or 110R are not larger than the predetermined value (no of operation 510), the control mode of the walking robot 100 is converted into an FSM-based control mode, and the motion of the walking robot 100 is controlled based on the FSM-based control mode (operation 516). The setting of the ZMP-based control mode of operation 514 is prepared for the conversion of the ZMP-based control mode into the FSM-based control mode, which will be performed in the next walking control of the robot 100, and the substantial control of the walking robot 100 is performed based on the FSM-based control mode obtained by the conversion of operation 516.

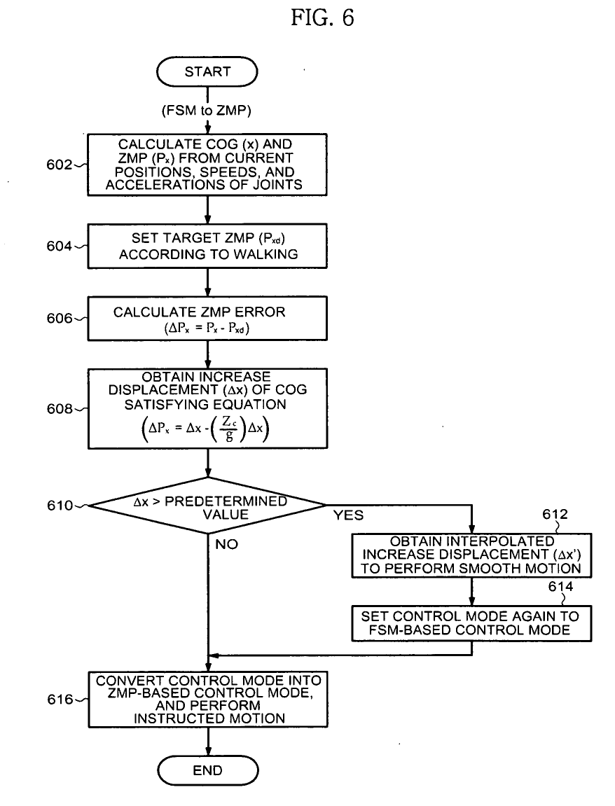

FIG. 6 is a view illustrating a method of converting a FSM-based control mode into a ZMP-based control mode in the walking robot in accordance with the embodiment of the present invention. As shown in FIG. 6, when FSM-based walking control is performed, current center of gravity (COG; x) and ZMP (Pₓ) are calculated from current positions, speeds, and accelerations of the joints (operation 602). Further, a target stable ZMP (P_{xd}) located in a target step length is set (operation 604). A ZMP error (ΔPₓ=Pₓ−P_{xd}) between the current ZMP (Pₓ) and the target ZMP (P_{xd}) is calculated (operation 606). When the ZMP error (ΔPₓ) is calculated, the ZMP error (ΔPₓ) is applied to a ZMP equation and thus an increase displacement (Δx) of the COG satisfying the ZMP equation is obtained (operation 608). When the increase displacement (Δx) is larger than a predetermined value (yes of operation 610), an interpolated increase displacement (Δx′) is obtained (operation 612). The interpolated increase displacement (Δx′) serves to prevent the excessive motion of the torso 102 and the swing leg 110L or 110R such that the torso 102 and the swing leg 110L or 110R can smoothly move. After the interpolated increase displacement (Δx′) is obtained, the control mode of the walking robot 100 is set again to the FSM-based control mode (operation 614). On the other hand, when the increase displacement (Δx) is not larger than the predetermined value (no of operation 610), the control mode of the walking robot 100 is converted into a ZMP-based control mode, and the motion of the walking robot 100 is controlled based on the ZMP-based control mode (operation 616). The setting of the FSM-based control mode of operation 614 is prepared for the conversion of the FSM-based control mode into the ZMP-based control mode, which will be performed in the next walking control of the robot 100, and the substantial control of the walking robot 100 is performed based on the ZMP-based control mode obtained by the conversion of operation 616.

As apparent from the above description, the present invention provides a walking robot and a method of controlling the same, in which one method is selected from a ZMP control method and a FSM control method in consideration of characteristics of a motion to be performed, the current control mode of the walking robot is converted into a different control mode, and the motion is performed based on the converted control mode, to enhance the efficiency and performance of the walking robot.

Although an embodiment of the present invention has been shown and described, it would be appreciated by those skilled in the art that changes may be made in this embodiment without departing from the principles and spirit of the invention, the scope of which is defined in the claims and their equivalents.

What is claimed is:

1. A method of controlling a walking robot, comprising:
receiving an instruction to perform a motion;
selecting a mode, comprising determining which mode is more proper to perform the instructed motion, out of a position-based first control mode and a torque-based second control mode; and
performing the instructed motion according to the selected control mode.

2. The method according to claim 1, wherein:
the first control mode is a ZMP-based control mode; and
the second control mode is an FSM-based control mode.

3. The method according to claim 2, wherein the selecting comprises selecting the ZMP-based control mode when the instructed motion to be performed requires precise position control.

4. The method according to claim 2, further comprising converting between the first control mode and the second control mode in order to perform the instructed motion.

5. The method according to claim 4, wherein the converting from the first control mode to the second control mode includes:
calculating position errors between current positions and target positions of the walking robot;
calculating increase displacements of the walking robot based on the position errors; and
converting the first control mode into the second control mode, when the increase displacements are not larger than a predetermined value.

6. The method according to claim 5, wherein the increase displacements of the walking robot include an increase displacement of a torso of the walking robot and an increase displacement of a swing leg of the walking robot.

7. The method according to claim 5, wherein the converting from the first control mode to the second control mode further includes:
obtaining interpolated increase displacements, when the increase displacements are larger than the predetermined value; and
performing the instructed motion based on the interpolated increase displacements.

8. The method according to claim 7, further comprising resetting the control mode of the walking robot to the first control mode in preparation for the subsequent conversion from the first control mode to the second control mode, when the interpolated increase displacements are obtained.

9. The method according to claim 8, wherein substantial performance of the instructed motion is achieved in the second control mode, although the control mode of the walking robot is set again to the first control mode.

10. The method according to claim 4, wherein the conversting from the second control mode to the first control mode includes:
calculating a ZMP error between a current ZMP and a target ZMP of the walking robot;
calculating an increase displacement of the walking robot through the ZMP error; and
converting the second control mode into the first control mode, when the increase displacement is not larger than a predetermined value.

11. The method according to claim 10, wherein the increase displacement of the walking robot is an increase displacement of a center of gravity (COG) of the walking robot.

12. The method according to claim 10, wherein the conversion from the second control mode to the first control mode further includes:
obtaining an interpolated increase displacement, when the increase displacement is larger than the predetermined value; and
performing the instructed motion based on the interpolated increase displacement.

13. The method according to claim 12, further comprising resetting the control mode of the walking robot to the second control mode in preparation for the subsequent conversion from the second control mode to the first control mode, when the interpolated increase displacement is obtained.

14. The method according to claim 13, wherein the substantial performance of the instructed motion is achieved in the first control mode, although the control mode of the walking robot is set again to the second control mode.

15. A walking robot comprising:
a torso;
a plurality of legs supporting the torso; and
a controller receiving an instruction to perform a motion, selecting a mode, which is determined to be more proper to perform the instructed motion, out of a position-based first control mode and a torque-based second control mode, and performing the instructed motion according to the selected control mode.

16. The walking robot according to claim 15, wherein:
the first control mode is a ZMP-based control mode; and
the second control mode is a FSM-based control mode.

17. The walking robot according to claim 16, wherein the controller selects the ZMP-based control mode when the instructed motion to be performed requires precise position control.

18. The walking robot according to claim 16, wherein the controller carries out the conversion between the first control mode and the second control mode in order to perform the instructed motion.

19. The walking robot according to claim 16, wherein the controller includes a state data storing unit to store predetermined state data to perform the FSM-based control mode.

20. A method of controlling a walking robot, comprising:
determining a difficulty and a slope of a surface on which the robot walks;
selecting an FSM-based walking control if the slope is even and the difficulty is relatively easy; and
selecting a ZMP-based walking control if the slope is not even or the difficulty is relatively difficult.
